(19) United States
(12) Patent Application Publication
(10) Pub. No.: US 2026/0045664 A1
(43) Pub. Date: Feb. 12, 2026

(54) BATTERY PACK

(71) Applicant: MURATA MANUFACTURING CO., LTD., Kyoto (JP)

(72) Inventor: Atsushi CHINEN, Kyoto (JP)

(21) Appl. No.: 19/289,346

(22) Filed: Aug. 4, 2025

(30) Foreign Application Priority Data
Aug. 9, 2024 (JP) 2024-134564

(51) Int. Cl. H01M 50/583; H01M 50/204; H01M 50/227; H01M 50/233; H01M 50/296; H01M 50/503

(52) U.S. Cl. CPC H01M 50/583; H01M 50/204; H01M 50/227; H01M 50/233; H01M 50/296; H01M 50/503; H01M 2200/103

(57) ABSTRACT

A battery pack is provided and including an exterior case and a battery module housed in the exterior case, in which the exterior case includes a connector electrically connected to the battery module and a heat-sensitive deformation portion positioned on an outer surface of the exterior case, the battery module includes a battery and a tab electrically connected to the battery and the connector, the tab includes a fusible portion, and the heat-sensitive deformation portion and the fusible portion are connected to each other in a thermally conductive manner.

### CROSS REFERENCE TO RELATED APPLICATIONS

The present application claims priority to Japanese Patent Application No. 2024-134564, filed on Aug. 9, 2024, the entire contents of which are incorporated herein by reference.

### BACKGROUND

The present disclosure relates to a battery pack.

A bus bar is disclosed that connects external terminals of different power storage elements in a conductive manner in a power storage device. The bus bar includes a fusible portion having a smaller width dimension than other portions. When an overcurrent flows, heat generated in the bus bar stays in the fusible portion, and the fusible portion is blown by high temperature. This causes a current path to be interrupted.

Since the fusible portion that interrupts the current path is located inside the power storage device, it is not possible to externally check whether the current path is interrupted. Therefore, there is a possibility that the power storage device in which the current path is already interrupted is erroneously reused.

### SUMMARY

The present disclosure relates to a battery pack.

The present disclosure, in an embodiment, relates to providing a battery pack capable of externally checking an interruption state of the current path.

A battery pack according to an embodiment of the present disclosure is provided.

The battery pack, in an embodiment, includes an exterior case and a battery module housed in the exterior case,
the exterior case includes a connector electrically connected to the battery module and a heat-sensitive deformation portion positioned on an outer surface of the exterior case,
the battery module includes a battery and a tab electrically connected to the battery and the connector,
the tab includes a fusible portion, and
the heat-sensitive deformation portion and the fusible portion are connected to each other in a thermally conductive manner.

According to an embodiment of the present disclosure, there is provided a battery pack capable of externally checking the interruption state of the current path.

### BRIEF EXPLANATION OF THE FIGURES

FIG. 1 is a schematic perspective view illustrating an appearance of a battery pack according to an embodiment of the present disclosure;

FIG. 2 is a schematic side view of the battery pack illustrated in FIG. 1;

FIG. 3 is a schematic sectional view illustrating a section A-A of the battery pack illustrated in FIG. 1;

FIG. 4 is a schematic side view of the battery pack illustrated in FIG. 1 excluding an exterior case;

FIG. 5 is a schematic perspective view of a tab according to the embodiment of the present disclosure;

FIG. 6 is a schematic circuit diagram of the battery pack according to the embodiment of the present disclosure;

FIG. 7 is a schematic sectional view illustrating a section C-C of the battery pack illustrated in FIG. 3;

FIG. 8 is a schematic enlarged sectional view of a portion D of the battery pack illustrated in FIG. 7;

FIG. 9 is a schematic enlarged sectional view illustrating a state in which a fusible portion is broken;

FIG. 10A is a schematic enlarged view illustrating a portion B of the battery pack illustrated in FIG. 2 before the fusible portion is broken;

FIG. 10B is a schematic enlarged view illustrating the portion B of the battery pack illustrated in FIG. 2 after the fusible portion is broken;

FIG. 11 is a schematic enlarged sectional view of the battery pack according to another embodiment;

FIG. 12A is a schematic enlarged view illustrating a state of a heat-sensitive deformation portion before the fusible portion is broken in the battery pack illustrated in FIG. 11;

FIG. 12B is a schematic enlarged view illustrating a state of the heat-sensitive deformation portion after the fusible portion is broken in the battery pack illustrated in FIG. 11;

FIG. 13 is a schematic enlarged sectional view of the battery pack according to another embodiment;

FIG. 14 is a schematic enlarged sectional view of the battery pack according to another embodiment;

FIG. 15 is a schematic enlarged sectional view of the battery pack according to another embodiment;

FIG. 16 is a schematic enlarged sectional view of the battery pack according to another embodiment;

FIG. 17 is a schematic enlarged view illustrating the state of the heat-sensitive deformation portion after the fusible portion is broken in the battery pack illustrated in FIG. 16;

FIG. 18 is a schematic enlarged view illustrating a vicinity of the heat-sensitive deformation portion of the battery pack according to another embodiment;

FIG. 19 is a schematic enlarged sectional view of the battery pack according to another embodiment; and

FIG. 20 is a schematic enlarged sectional view of the battery pack according to another embodiment.

### DETAILED DESCRIPTION

The present disclosure will be described in further detail including with reference to the figures according to an embodiment. The present disclosure is not limited thereto In consideration of the description of the main points or ease of understanding, the present disclosure may be separated into the embodiments and the like to be described for convenience, but partial replacement and/or combination of configurations described in different embodiments and the like can be made. In the description of such embodiments, redundant description of substantially the same matters may be omitted, and only different points may be described. In particular, the same functions and effects by the same configurations may not be sequentially mentioned for each embodiment.

Various numerical ranges mentioned in the present specification are intended to include lower and upper numerical values themselves, unless otherwise specified. Note that the term “about” means that it may include variations or differences of a few percent, for example, ±10%.

Hereinafter, a battery pack according to an embodiment of the present disclosure will be described with reference to the drawings. Although the description will be made with reference to the drawings as necessary, the illustrated contents are merely schematically and exemplarily illustrated for understanding of the present disclosure, and appearance, dimensional ratio, and the like may be different from actual ones.

A “Z direction” mentioned in the present specification refers to a thickness direction of an object (for example, the battery pack), and a drawing viewed from the Z direction is a top view. A “Y direction” refers to a height direction of a battery housed in the battery pack, and a drawing viewed from the Y direction is a front view. An “X direction” refers to a direction orthogonal to the Z direction and the Y direction, and a drawing viewed from the X direction is a side view. That is, the X direction, the Y direction, and the Z direction refer to a relationship that they are orthogonal to each other. Although the X direction, the Y direction, and the Z direction are illustrated in the drawings, a direction of an arrow is intended to be a positive direction (or a + direction), and a direction opposite to the direction of the arrow is intended to be a negative direction (or a − direction).

The term “sectional view” mentioned in the present specification corresponds to capturing a section cut in a direction perpendicular to a thickness of an arbitrary surface of an exterior case CS from a direction perpendicular to an extending direction of the section. In addition, the term “plan view” mentioned in the present specification corresponds to capturing the object from a direction perpendicular to an extending direction of an arbitrary surface of the exterior case CS (that is, from a thickness direction of the surface).

The present disclosure relates to a configuration of the battery pack that houses a battery module. First, in order to grasp an overall structure of the battery pack of the present disclosure, a basic configuration of the battery pack and the battery module of the present disclosure will be described below with reference to the drawings.

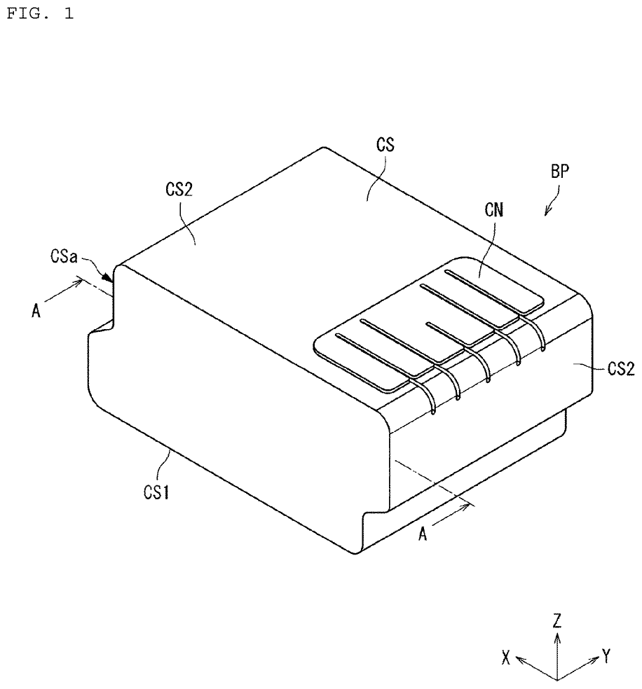

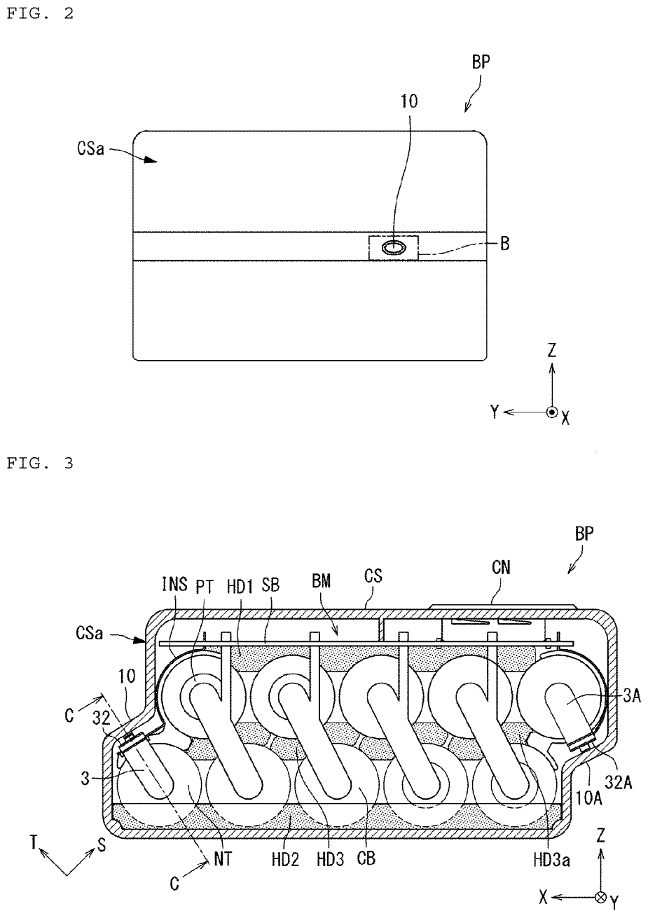

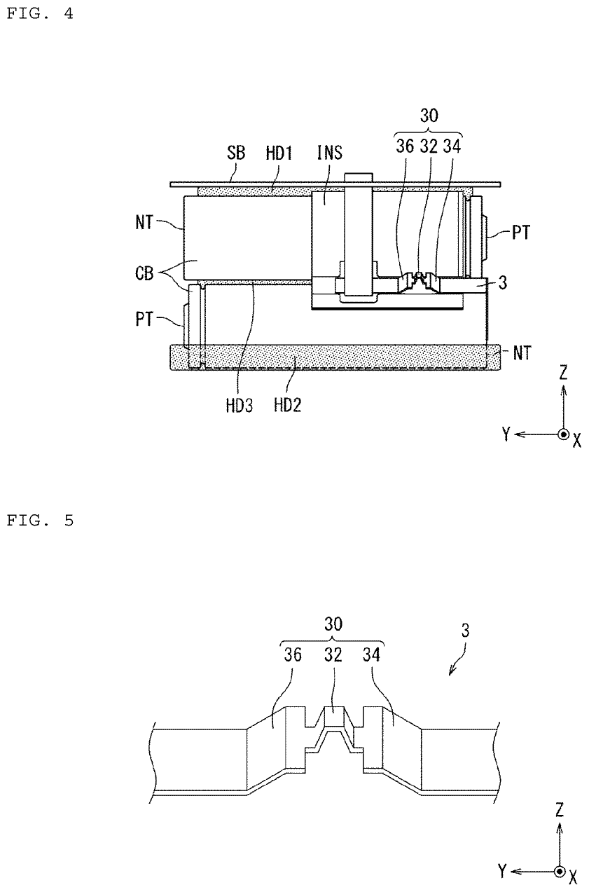

A battery pack BP of the present disclosure will be described with reference to FIGS. 1 to 3. FIG. 1 is a schematic perspective view illustrating an appearance of the battery pack BP according to an embodiment of the present disclosure. FIG. 2 is a schematic side view of the battery pack BP illustrated in FIG. 1. FIG. 3 is a schematic sectional view illustrating a section A-A of the battery pack BP illustrated in FIG. 1. FIG. 4 is a schematic side view of components of the battery pack illustrated in FIG. 1, excluding the exterior case CS, as viewed in a −X direction.

The battery pack BP may include the exterior case CS and a battery module BM housed in the exterior case CS (see FIGS. 1 and 3). Note that detailed description of the battery module BM will be described later with reference to items.

The exterior case CS may have a box shape constituting a housing space for housing the battery module BM. The exterior case CS can be understood as an outer housing surrounding the battery module BM, and can also be referred to as a pack outer housing or the like. For example, the exterior case CS may have a box shape including two end surfaces CS1 located on a terminal side of the battery housed in the battery pack and facing each other, and a side surface CS2 connecting the two end surfaces CS1. In such an exterior case CS, for example, the housing space may be configured by a combination of two or more case members.

The exterior case CS may be provided with a connector CN electrically connected to the battery module BM. The connector CN can function as a terminal for extracting electric power from the battery module BM. The connector CN may be provided on an outer surface CSa of the exterior case CS. In the exemplary battery pack BP illustrated in FIG. 1, an aspect in which the connector CN is provided on the side surface CS2 of the exterior case CS is illustrated, but a position of the connector CN is not limited thereto. For example, the connector CN may be positioned on the end surface CS1 of the exterior case CS.

The battery module BM of the present disclosure will be described with reference to FIGS. 3 and 4.

The battery module BM of the present disclosure may mainly include a battery CB, a battery holder HD, a tab 3, and a control board SB. Hereinafter, each configuration will be described in detail.

The battery CB is intended to be a chemical battery that mainly converts chemical energy into direct current power by a chemical reaction. Although the battery CB used in the battery module BM illustrated in FIGS. 3 and 4 is a cylindrical battery having a cylindrical axis in a ±Y direction, a shape of the battery is not particularly limited. For example, a battery CB having a shape other than a cylindrical shape (for example, an elliptical cylindrical shape, a rectangular columnar shape, a polygonal columnar shape, or the like) may be used.

The battery module BM of the present disclosure may include two or more batteries CB. The batteries CB may be arranged adjacent to each other. For example, in an aspect illustrated in FIG. 3, five batteries CB may be arranged in a row so as to be adjacent to each other in the X direction, and may be arranged in a matrix so as to be stacked in a +Z direction to form two columns (a total of 10 batteries CB may be provided). For example, as illustrated in FIG. 3, the batteries CB may be arranged in a staggered manner such that the batteries CB in each row alternate when viewed from the Y direction. Note that the number of batteries and a stacking pattern are not limited to the aspect in FIG. 3.

The battery holder HD may function as a member that holds and/or fixes the battery CB in the housing space of the exterior case CS. For example, as illustrated in FIG. 3, the battery holder HD may be provided on the +Z direction side and a −Z direction side of the battery CB. That is, the battery holder HD may be fitted onto the battery CB so as to sandwich the battery holder HD from both sides in the ±Z direction to restrict movement of the battery CB in the exterior case CS. The number of battery holders HD is not particularly limited, and the battery holder HD may be constituted by two or more members.

For example, as illustrated in FIG. 3, three types of battery holders HD1 to HD3 positioned between the plurality of batteries CB and between the battery CB and other components may be used. Specifically, the battery pack BP may be provided with a first battery holder HD1 positioned between the batteries CB and the control board SB, a second battery holder HD2 extending along a side surface on the −Z direction side of the exterior case CS and positioned between the exterior case CS and the batteries CB, and a third battery holder HD3 positioned between rows of the batteries CB. The first battery holder HD1 and the second battery holder HD2 each may be arranged to fill a gap between the batteries CB and the control board SB or between the batteries CB and the exterior case CS. For example, the first battery holder HD1 and the second battery holder HD2 may have side surfaces bent along an outer periphery of the battery CB, and be capable of coming into contact with the battery CB at the side surfaces. This can restrict the movement of the battery CB in a ±X direction in the exterior case CS.

More specifically, first battery holder HD1 can appropriately keep a separation distance between the exterior case CS and the battery CB, and can contribute to maintaining positions of the control board SB and the battery CB in exterior case CS. The second battery holder HD2 can contribute to maintaining the separation distance between the exterior case CS and the battery CB.

The third battery holder HD3 may be disposed between the columns of the batteries CB adjacent to each other. The third battery holder HD3 may have a shape along a side surface shape of the battery CB so as to be fitted into a gap existing between the rows of the batteries CB. With such a third battery holder HD3, an interval between the plurality of batteries CB may be appropriately maintained. For example, as illustrated in FIG. 3, the battery pack BP may include a plurality of the third battery holders HD3. The plurality of third battery holders HD3 may have the same shape as each other, or some of the third battery holders HD3 may have different shapes such as a shape having a recessed portion like a third battery holder HD3a in FIG. 3. Alternatively, the third battery holder HD3 may be formed of one integrally molded member.

By providing the battery holder HD as described above, a position of the battery CB (for example, the interval between the battery CB and the battery CB) in the exterior case CS can be appropriately maintained. Thus, damage to the battery pack BP due to unintended movement of the battery CB can be suppressed. For example, in a metal plate generally used as a material of the tab 3, deformation of the tab 3 due to buckling, peeling of the tab 3 from the battery CB, and the like due to the movement of the battery CB can be suitably suppressed.

The shape of the battery holder HD is not particularly limited as long as arrangement of the batteries CB as described above can be maintained. For example, the battery holder HD may be a single member made of one member, and the battery CB may be held and/or fixed by inserting the battery CB from the +Y direction or the −Y direction to the battery holder HD. A direction of sandwiching the battery CB by the battery holder HD is not limited to the ±Z direction, and the battery holder HD may be configured to sandwich the battery CB from both sides in the ±Y direction.

At least a partial region of a positive electrode terminal PT and a negative electrode terminal NT of the battery CB may be exposed from the battery holder HD. The positive electrode terminal PT and the negative electrode terminal NT not covered with the battery holder HD may be electrically connected to the tab 3. That is, the tab 3 may be electrically connected to the battery CB in a region not covered by the battery holder HD.

As illustrated in FIG. 3, the tab 3 may electrically connect the positive electrode terminal PT and/or the negative electrode terminal NT of the adjacent batteries CB to each other. The tab 3 has conductivity. The term “conductivity” in the present specification means that volume resistivity is 10⁵ Ω·cm or less. For example, as illustrated in FIG. 3, in two batteries CB located in different rows and adjacent to each other, the tab 3 may electrically connect the batteries in series by electrically connecting the positive electrode terminal PT of one battery CB and the negative electrode terminal NT of the other battery CB.

The tab 3 can function as an electrical connection member that electrically connects the plurality of batteries CB together and/or between the battery CB and the control board SB described later. Such a tab 3 includes a fusible portion 32 which is fusible when an overcurrent flows therethrough. Specifically, the fusible portion 32 can be broken by being melted by Joule heat generated when the overcurrent flows therethrough. Such a fusible portion 32 can function as a so-called fuse that interrupts an electric circuit by blowing when the overcurrent flows through the electric circuit. The fusible portion 32 can also be referred to as, for example, a fuse, a fusible link, a thermal fusion portion, an overcurrent interrupting portion, a fusible portion, or the like.

The fusible portion 32 may be provided at any position of the tab 3 constituting the electric circuit of the battery pack BP. For example, the fusible portion 32 may be provided on a tab that electrically connects the plurality of batteries CB together. Alternatively, as illustrated in FIG. 4 and the like, the fusible portion 32 may be provided on a tab that connects the battery CB and the control board SB. Specifically, the fusible portion 32 may be located between a first tab 34 electrically connected to the battery CB and a second tab 36 electrically connected to the control board SB, and may electrically connect the first tab 34 and the second tab 36 to each other. That is, the first tab 34 and the second tab 36 may be electrically connected with the fusible portion 32 interposed therebetween. In such a structure, when the fusible portion 32 is blown, an electrical connection between the control board SB and the battery CB is interrupted.

A material and a shape of the fusible portion 32 are not particularly limited as long as it can be blown by the overcurrent. For example, the fusible portion 32 may be formed of a low melting point material that is melted by the heat generated by the overcurrent. Such a fusible portion 32 may be formed of a material different from a portion (for example, the first tab 34 and the second tab 36) other than the fusible portion 32, and may be electrically connected using various fixing means such as caulking.

Alternatively, the fusible portion 32 may have a structure that locally increases a calorific value when the overcurrent flows therethrough by having a higher electrical resistance than the portion other than the fusible portion 32 in the tab 3. FIG. 5 is a partly enlarged view schematically illustrating the fusible portion of an exemplary tab 3. For example, as shown in FIG. 5, the tab 3 may have a structure in which the electrical resistance is locally increased in the fusible portion 32 by locally reducing a width dimension of the tab 3 in the fusible portion 32. Such a fusible portion 32 may be formed of the same material as the tab 3. For example, the tab 3 and the fusible portion 32 may be integrally formed.

The control board SB may be disposed on an outer surface of the battery holder HD in FIG. 3 illustrating an example. The control board SB may be electrically connected to the tab 3. The control board SB may be electrically connected to the battery CB with the tab 3 interposed therebetween. Thus, the control board SB may receive power from the battery CB through the tab 3 connected to the control board SB. In addition, the power output from the battery CB through the tab 3 may be controlled.

The battery pack BP may include further components. For example, as illustrated in FIGS. 3 and 4, an insulating member INS for preventing a short circuit between the battery CB and the tab 3 may be disposed between the battery CB and the tab 3.

The battery pack of the present disclosure is characterized by having a structure in which a blown state of the fusible portion 32 can be determined from an outside of the exterior case CS. Hereinafter, details of the features will be described with reference to the drawings according to an embodiment.

As illustrated in FIG. 2, the exterior case CS includes a heat-sensitive deformation portion 10 on the outer surface CSa. In short, the “heat-sensitive deformation portion” in the present specification means a portion configured to be deformable according to temperature. More specifically, the heat-sensitive deformation portion 10 is a portion configured to be deformable by application of heat to such an extent that the presence or absence of deformation can be visually determined. That is, the heat-sensitive deformation portion 10 is a portion that can be deformed to such an extent that a difference between a shape before the heat is applied and a shape after the heat is applied can be visually determined. An aspect of the deformation is not particularly limited as long as it can be visually determined, and examples thereof include deformation due to partial melting, expansion, contraction, breakage, and/or blowing. Such a heat-sensitive deformation portion 10 can also be referred to as, for example, a thermally deformable portion, a thermally responsive shape variable portion, a thermally sensitive shape variable portion, or the like.

The heat-sensitive deformation portion 10 is connected in a thermally conductive manner to the fusible portion 32 of the tab 3 housed in the exterior case CS. The term “connected in a thermally conductive manner” is not limited to direct connection, and includes connection via any member having thermal conductivity. That is, the battery pack BP of the present disclosure may be configured such that the heat generated in the fusible portion 32 can be transferred to the heat-sensitive deformation portion 10. Such a configuration can also be understood as that the heat-sensitive deformation portion 10 is thermally connected to the fusible portion 32. With such a structure, the heat-sensitive deformation portion 10 can be deformed in response to the heat generated in the fusible portion 32.

As described above, the fusible portion 32 is blown due to the Joule heat generated by abnormal overcurrent. The heat generated at this time is transferred to the heat-sensitive deformation portion 10 located on the outer surface CSa of the exterior case CS, so that the heat-sensitive deformation portion 10 can be deformed. The heat-sensitive deformation portion 10 is configured to be deformable in response to heat transferred from the fusible portion 32 when a temperature (hereinafter, also simply referred to as “blowing temperature”) at which the fusible portion 32 is blown due to the overcurrent is reached. In short, when the fusible portion 32 of the tab 3 reaches the blowing temperature, the deformation occurs in the heat-sensitive deformation portion 10 of the exterior case CS. More specifically, the heat-sensitive deformation portion 10 is deformable when the fusible portion 32 reaches the blowing temperature and the temperature rises to a predetermined temperature due to the heat transferred from the fusible portion 32. On the other hand, the heat-sensitive deformation portion 10 is not deformed when the temperature of the fusible portion 32 is equal to or lower than the blowing temperature.

According to such a configuration of the present disclosure, the heat-sensitive deformation portion 10 can function as an indicator indicating the blown state of the fusible portion 32. A worker can determine whether the fusible portion 32 has reached the blowing temperature by checking the presence or absence of the deformation of the heat-sensitive deformation portion 10 on the outer surface CSa of the exterior case CS. That is, it is possible to check the blown state regarding the presence or absence of blowing of the fusible portion 32 in the exterior case CS from the outside of the exterior case CS.

According to the present disclosure, it is possible to indirectly determine the blown state of the fusible portion 32 from the outside without requiring an operation for direct visual recognition such as installation of an opening such as a window in the exterior case CS or disassembly of the battery pack BP. This makes it possible to determine the blown state of the fusible portion 32 without exposing the battery module BM housed in the exterior case CS to the outside. Therefore, when the blown state of the fusible portion 32 is checked, entry of moisture and/or foreign matter such as dust into the battery module BM can be suitably suppressed.

The configuration of the battery pack of the present disclosure can also be advantageous when the battery pack includes a plurality of the fusible portions 32. For example, it is conceivable to use the fusible portion 32 as a means for checking the blown state to check a conduction state. However, when the battery pack includes the plurality of fusible portions 32, it is difficult to determine from the outside which fusible portion 32 has been blown.

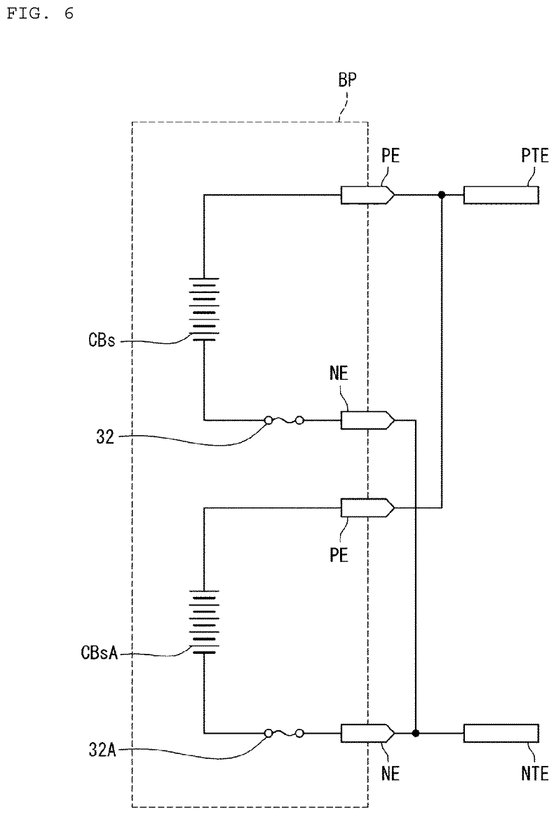

In particular, when the battery module BM has a parallel circuit in which a plurality of sets of batteries CB are connected in parallel, at least one fusible portion 32 can be incorporated for each of the battery CB sets. FIG. 6 illustrates a schematic circuit diagram of an exemplary battery pack BP including the parallel circuit. As illustrated, the battery pack BP may include two battery sets CBs and CBsA including the plurality of batteries CB. A positive electrode PE of the battery set CBs and a positive electrode PE of the battery set CBsA may be connected, to be guided to an external positive electrode terminal PTE of the connector CN (see FIG. 1). Similarly, a negative electrode NE of the battery set CBs and a negative electrode NE of the battery set CBsA may be connected, to be guided to an external negative electrode terminal NTE of the connector CN. Thus, the battery set CBs and the battery set CBsA may be connected in parallel. The fusible portions 32 and 32A may be respectively inserted into the two battery sets CBs and CBsA. The exterior case CS may include a plurality of heat-sensitive deformation portions 10 and 10A respectively connected to the fusible portions 32 and 32A in a thermally conductive manner (see FIG. 3). Specifically, the exterior case CS may include the heat-sensitive deformation portion 10 connected to the fusible portion 32 in a thermally conductive manner and the heat-sensitive deformation portion 10A connected to the fusible portion 32A in a thermally conductive manner.

When an abnormal current flows in the battery module BM of such a parallel circuit, there is a possibility that a voltage applied to the circuit is temporarily lowered when any of the plurality of fusible portions 32 is blown, and thus other fusible portions 32 are not disconnected. That is, in the battery module BM, there may be a battery CB set in which the fusible portion 32 is blown and a battery CB set in which the fusible portion 32 is not blown. In such a battery module BM, since the electric circuit is not thoroughly interrupted, the blown state of the fusible portion 32 cannot be determined by the presence or absence of conduction. When such a battery module BM is normally used, there is a possibility that the number of parallel connections of the batteries CB originally required at the time of parallel connection cannot be secured, and an overcurrent exceeding a design expectation flows through the battery CB set in which the circuit remains.

According to the present disclosure, by providing the plurality of heat-sensitive deformation portions 10 respectively connected to the plurality of fusible portions 32 in a thermally conductive manner, the blown state of each of the plurality of fusible portions 32 can be visually recognized from the outside of the exterior case CS. That is, it is possible to check from the outside of the battery pack BP which fusible portion 32 among the plurality of fusible portions 32 is blown and whether there is any fusible portion 32 that is not blown. As described above, it is possible to prevent continuous use of the battery pack BP in which a failure has occurred by clearly indicating whether the fusible portion 32 is blown so as to be visible from the outside.

FIG. 7 is a sectional view schematically illustrating a section C-C of the heat-sensitive deformation portion 10 illustrated in FIG. 3. Note that the section C-C is a section cut in a thickness direction T (hereinafter, also simply referred to as “the thickness direction T of the exterior case CS”) of the surface of the exterior case CS where the heat-sensitive deformation portion 10 is located. As illustrated, the heat-sensitive deformation portion 10 and the fusible portion 32 may be arranged to face each other in the thickness direction T of the exterior case CS. For example, the heat-sensitive deformation portion 10 and the fusible portion 32 may be located coaxially with each other in the thickness direction T of the exterior case CS. In the present specification, “located coaxially” means that when viewed from the thickness direction T of the exterior case CS, the heat-sensitive deformation portion 10 and the fusible portion 32 have an arrangement relationship in which they at least partly overlap.

With such a structure, the heat-sensitive deformation portion 10 is disposed at a position corresponding to a position where the fusible portion 32 is disposed on the outer surface CSa of the exterior case CS. Thus, a distance between the heat-sensitive deformation portion 10 and the fusible portion 32 is shortened, and the heat from the fusible portion 32 can be more suitably transferred to the heat-sensitive deformation portion 10. Therefore, the heat-sensitive deformation portion 10 can more suitably reflect the blown state of the fusible portion 32.

Furthermore, since the heat-sensitive deformation portion 10 is disposed at a position corresponding to the fusible portion 32 in the exterior case CS, the worker can grasp arrangement of the fusible portion 32 from the outside of the exterior case CS. Such a structure can be particularly advantageous when the battery module BM includes the plurality of fusible portions 32. For example, the plurality of heat-sensitive deformation portions 10 may be respectively arranged at positions corresponding to the plurality of fusible portions 32. By visually recognizing each of the heat-sensitive deformation portions 10 from the outside of the exterior case CS, the worker can easily check at which position the fusible portion 32 is blown. That is, according to the present disclosure, a position of the blown fusible portion 32 can be visually recognized from the outside of the exterior case CS.

The fusible portion 32 may be in contact with an inner surface CSb of the exterior case CS at a position facing the heat-sensitive deformation portion 10. In other words, the exterior case CS may include the heat-sensitive deformation portion 10 on the outer surface CSa, while being in contact with the fusible portion 32 on the inner surface CSb facing the heat-sensitive deformation portion 10. Thus, a distance of heat transfer from the fusible portion 32 to the heat-sensitive deformation portion 10 can be made substantially the same as a thickness dimension of the exterior case CS. Therefore, more efficient heat transfer from the fusible portion 32 to the heat-sensitive deformation portion 10 can be achieved, and thermal responsiveness of the heat-sensitive deformation portion 10 to temperature rise of the fusible portion 32 can be improved.

The heat-sensitive deformation portion 10 may be formed of a material that can be deformed according to the temperature. Preferably, the heat-sensitive deformation portion 10 may be integrally molded with the exterior case CS. A material of the exterior case CS may be, for example, a thermoplastic resin material (for example, plastic) or a metal material. Examples of the resin material include polycarbonate (PC), acrylonitrile butadiene styrene (ABS), polycarbonate ABS (PCABS), polybutylene terephthalate (PBT), polyethylene, nylon, modified polyphenylene ether (m-PPE), and polyamide (PA). Examples of the metal material include aluminum.

When the heat-sensitive deformation portion 10 is integrally molded with the exterior case CS, the material of the exterior case CS is more preferably the thermoplastic resin material. In general, the thermoplastic resin material is inferior in thermal conductivity to a metal. Therefore, when the material of the exterior case CS is the thermoplastic resin material, the heat transferred from the fusible portion 32 to the heat-sensitive deformation portion 10 is less likely to be diffused over the entire exterior case CS, and deformation due to thermal response can be locally generated in the heat-sensitive deformation portion 10. Thus, the heat-sensitive deformation portion 10 can more clearly indicate a heat generation state (that is, a broken state of the fusible portion 32) in the fusible portion 32.

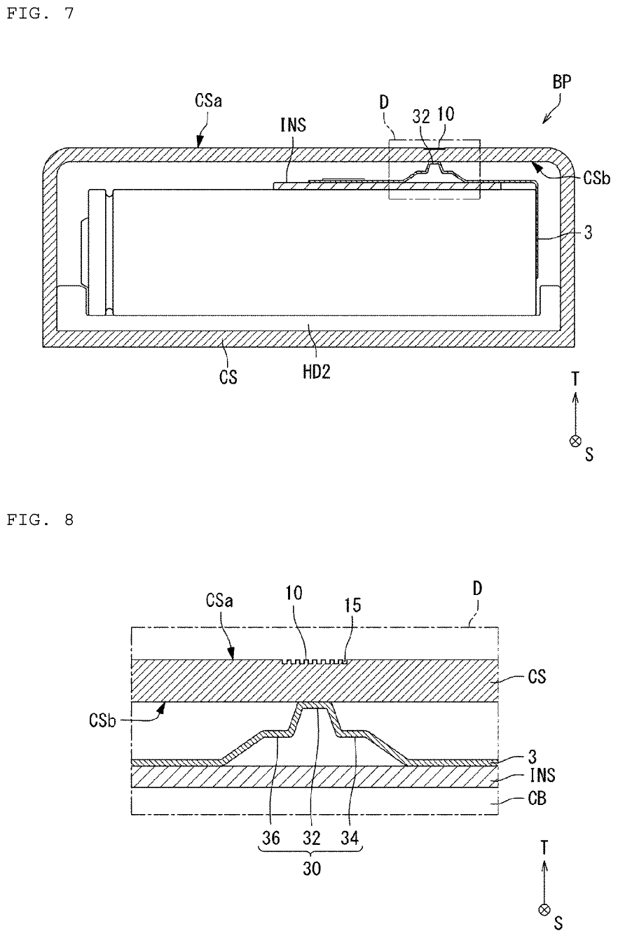

FIG. 8 is a schematic partly enlarged view of a portion C of the battery pack BP illustrated in FIG. 7. As illustrated, the heat-sensitive deformation portion 10 may have a recess 15 in which the thickness of the exterior case CS is partly reduced. In other words, the heat-sensitive deformation portion 10 may be formed by presence of the recess 15 in which the thickness of the exterior case CS is partly reduced on the outer surface CSa of the exterior case CS. With such a shape, the heat-sensitive deformation portion 10 can be deformed in the recess 15 by the heat transferred from the fusible portion 32. That is, according to the battery pack of the present disclosure, the blown state of the fusible portion 32 can be determined by deformation of the recess 15 formed in the heat-sensitive deformation portion 10.

An aspect of the deformation of the recess 15 differs depending on a shape of the recess 15 before the deformation (that is, before blowing of the fusible portion 32). For example, the heat-sensitive deformation portion 10 including a plurality of micro recesses 15 as illustrated in FIG. 8 and the heat-sensitive deformation portion 10 including the recess 15 formed by recessing the entire heat-sensitive deformation portion 10 as illustrated in FIG. 16 can have different aspects of the deformation of the heat-sensitive deformation portion 10. Hereinafter, first, an aspect in which the heat-sensitive deformation portion 10 includes the plurality of micro recesses 15 will be described.

As illustrated in FIG. 8, the outer surface CSa of the exterior case CS may include a textured region in which the plurality of micro recesses 15 are formed at least in the heat-sensitive deformation portion 10. That is, the heat-sensitive deformation portion 10 may be textured. This can also be understood that, in the heat-sensitive deformation portion 10, the outer surface CSa of the exterior case CS is a micro uneven surface having fine irregularities.

In the present specification, the term “texture” refers to a shape having a repetitive pattern of fine irregularities on the outer surface CSa. The repetitive pattern of irregularities is not necessarily regular, but may have a shape including a plurality of irregular irregularities. The textured region refers to a region subjected to texturing, and can also be referred to as a micro uneven region, a fine uneven region, an embossed region, or the like. In FIG. 8, the irregularities of the textured region are schematically illustrated in consideration of ease of understanding, but can be different from an actual dimension of the irregularities. In subsequent drawings, in order to make the drawings easier to see, hatching is applied to the region subjected to the texturing, and illustration of the irregularities may be omitted.

In the textured region, since light incident on the textured region is diffused, a difference in gloss occurs between the textured region and a non-textured region not subjected to the texturing. Therefore, the textured region and the non-textured region can be visually discriminated by the gloss difference.

An average height of the irregularities of the textured region may be, for example, 3 μm or more. When the average height is within the above range, the gloss difference between the textured region and the non-textured region can be suitably determined. An upper limit value of the average height is not particularly limited, but may be, for example, 100 μm or less. Note that the average height is a value measured according to a method defined in JIS B0601:2001 using a stylus-type surface roughness measurement device in accordance with JIS B0651:2001.

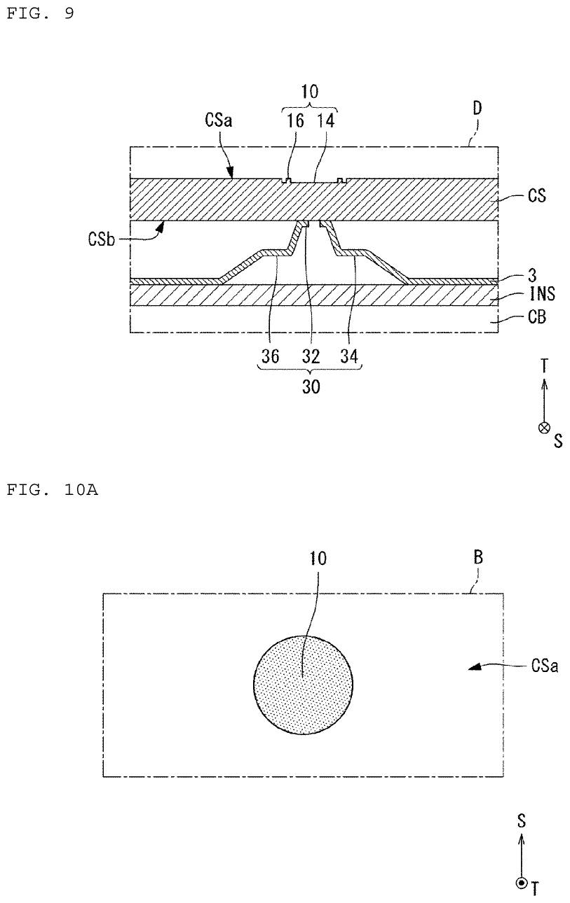

FIG. 9 is a partly enlarged view illustrating a state after the fusible portion 32 is blown in the battery pack BP illustrated in FIG. 8. FIGS. 10A and 10B are partly enlarged views each illustrating the heat-sensitive deformation portion 10 illustrated in FIG. 8 as viewed from the outside of the exterior case CS. FIG. 10A illustrates a state of the fusible portion 32 before blowing, and FIG. 10B illustrates a state of the fusible portion 32 after blowing. As illustrated, in the textured region in the heat-sensitive deformation portion 10, the irregularities forming the textured region are deformed by the heat from the fusible portion 32. Such a deformation changes the gloss of the textured region. For example, the irregularities of the textured region can be smoothed out by the heat transferred from the fusible portion 32. Here, the term “the irregularities are smoothed” includes not only that the unevenness is simply reduced but also that an outer contour shape of a protrusion constituting the irregularities is smoothed. Specifically, the deformation of the heat-sensitive deformation portion 10 includes not only reduction of the average height of the irregularities of the textured region but also reduction of curvature of a tip of the protrusion included in the textured region.

Due to such deformation of the irregularities, gloss of the heat-sensitive deformation portion 10 changes before and after blowing of the fusible portion 32. For example, by reducing irregularities in the textured region to be similar to a smooth flat surface, scattering of light incident on the heat-sensitive deformation portion 10 from the outside of the battery pack BP is suppressed, and an appearance with further increased gloss can be obtained as compared with that before the deformation. Alternatively, when curvature of a corner (for example, the tip of the protrusion) located on the tip side of the protrusion is reduced, the protrusion has a more rounded shape, and the scattering of the light incident on the heat-sensitive deformation portion 10 is suppressed. Thus, the appearance with further increased gloss can be obtained as compared with that before the deformation. Such a change in the gloss of the heat-sensitive deformation portion 10 makes it possible to determine the blown state of the fusible portion 32. When emphasizing the viewpoint of facilitating determination based on such a gloss difference, it is preferable that the textured region includes a protrusion having a sharp (for example, the curvature is large) corner so that the change in the gloss accompanying deformation of the protrusion is clearer.

When the heat-sensitive deformation portion 10 has the textured region, there can be a difference in an amount of heat transferred from the fusible portion 32 within a region of the heat-sensitive deformation portion 10. Due to the difference in the amount of heat, a difference also occurs in the deformation of the irregularities of the textured region, and gloss unevenness can occur in the heat-sensitive deformation portion 10. For example, the heat-sensitive deformation portion 10 may be configured such that a predetermined degree of the gloss difference is generated by heat transferred to the heat-sensitive deformation portion 10 when the fusible portion 32 reaches the blowing temperature. That is, the worker may be able to determine whether the fusible portion 32 that has generated heat is blown by checking a degree of the gloss unevenness in the heat-sensitive deformation portion 10.

For example, the heat-sensitive deformation portion 10 may be configured such that a gloss change region in the heat-sensitive deformation portion 10 exceeds a certain area when the fusible portion 32 reaches the blowing temperature. With such a structure, it is possible to determine that the fusible portion 32 is blown when the gloss change region in the heat-sensitive deformation portion 10 exceeds the certain area. Specifically, as illustrated in FIGS. 10A and 10B, the heat-sensitive deformation portion 10 may have a first region 14 and a second region 16, and both regions may be uniformly textured. For example, a central region of the heat-sensitive deformation portion 10 may be set as the first region 14, and a region around the first region 14 may be set as the second region 16. The heat-sensitive deformation portion 10 may be configured such that at least an entire first region 14 is deformed so as to exhibit a gloss different from that of the second region 16 when the fusible portion 32 reaches the blowing temperature. This makes it possible to more easily determine the deformation of the heat-sensitive deformation portion 10.

In such a configuration, a mark such as a line indicating a position of an outer edge of the first region 14 may be provided on the outer edge so that a range of the first region 14 for determining the blown state of the fusible portion 32 can be visually recognized. The mark may be formed by any method, for example, printing such as silk screen printing, laser marking, or the like.

Note that, FIGS. 10A and 10B illustrate the heat-sensitive deformation portion 10 having a substantially circular shape as viewed in the thickness direction T of the exterior case CS, but a shape of the heat-sensitive deformation portion 10 is not limited to the substantially circular shape. For example, the heat-sensitive deformation portion 10 may have any shape of an oval shape, an elliptical shape, a polygonal shape such as a triangle or a quadrangle, or an indefinite shape as viewed in the thickness direction T of the exterior case CS.

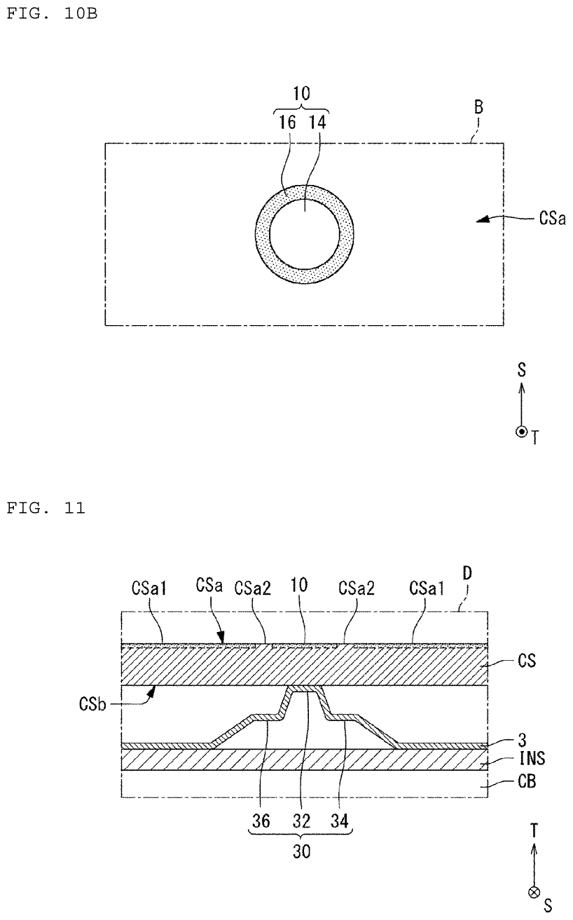

FIG. 11 is an enlarged sectional view schematically illustrating a periphery of the heat-sensitive deformation portion 10 of the battery pack BP according to an embodiment different from FIG. 8. As illustrated, the texturing may also be applied to a region CSa1 other than the heat-sensitive deformation portion 10 in the outer surface CSa of the exterior case CS. For example, the texturing may be applied over an entire region of the outer surface CSa excluding the heat-sensitive deformation portion 10.

Preferably, as illustrated in FIG. 11, while the heat-sensitive deformation portion 10 is textured, a region adjacent to the heat-sensitive deformation portion may not be textured. That is, the exterior case CS may include a non-textured region CSa2 adjacent to the textured region of the heat-sensitive deformation portion 10 on the outer surface CSa. The outer surface CSa of the exterior case CS may be textured over an entire surface excluding the non-textured region CSa2. In other words, in the exterior case CS, only the non-textured region CSa2 may be a region not subjected to the texturing.

The non-textured region CSa2 is a region having smoother irregularities than the textured region, and is not necessarily a smooth surface having no irregularities. For example, since a density (for example, the number of protrusions per unit area (peak point density Spd)) of the irregularities is lower than that of the textured region, the gloss difference between the textured region and the non-textured region may be suitably determinable.

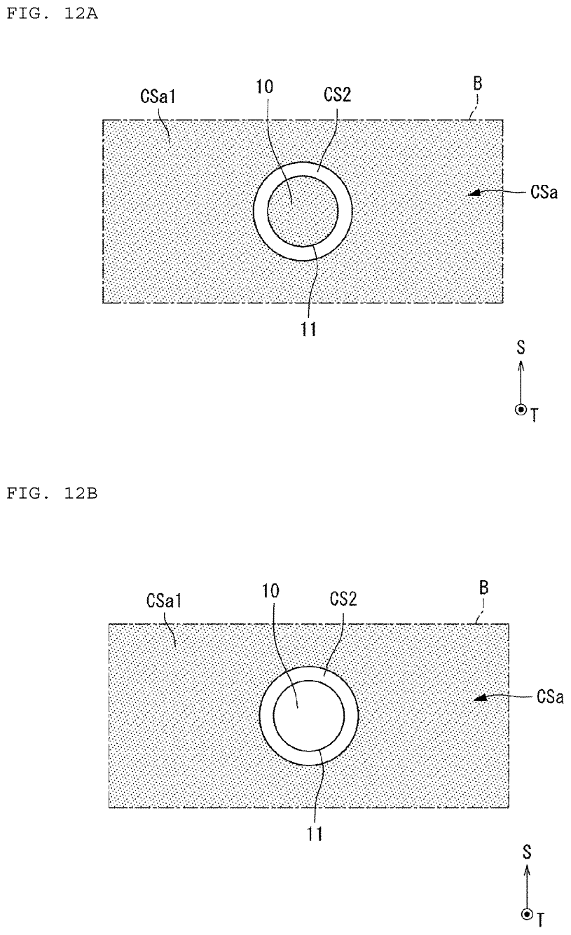

FIGS. 12A and 12B are partly enlarged views each illustrating the heat-sensitive deformation portion 10 illustrated in FIG. 11 as viewed from the outside of the exterior case CS. FIG. 12A illustrates a state of the fusible portion 32 before blowing, and FIG. 12B illustrates a state of the fusible portion 32 after blowing. As illustrated in FIG. 12A, the non-textured region CSa2 not subjected to the texturing may be positioned in a strip shape along an outer edge 11 of the heat-sensitive deformation portion 10 so as to surround the heat-sensitive deformation portion 10. That is, the annular non-textured region CSa2 may exist around the heat-sensitive deformation portion 10. In such a structure, the texturing may be applied to both an inside and an outside of the non-textured region CSa2 on the outer surface CSa of the exterior case CS.

As described above, when including the exterior case CS in which the heat-sensitive deformation portion 10 including the textured region and the non-textured region CSa2 are adjacent to each other, and the blowing of the fusible portion 32 occurs due to the overcurrent, the heat generated in the fusible portion 32 is transferred to the heat-sensitive deformation portion 10. The texture of the heat-sensitive deformation portion 10 is deformed by the transferred heat, and the irregularities are smoothed. Thus, the gloss difference between the heat-sensitive deformation portion 10 including the textured region and the non-textured region CSa2 adjacent to the textured region is reduced (see FIG. 12B). According to such a battery pack BP, the non-textured region CSa2 can function as a reference for determining the change in the gloss accompanying the deformation of the heat-sensitive deformation portion 10. For example, the heat-sensitive deformation portion 10 may be configured to be deformed to an extent of exhibiting gloss equivalent to that of the non-textured region CSa2 by the heat transferred from the fusible portion 32 when the fusible portion 32 reaches the blowing temperature. Thus, the worker can suitably determine the blown state of the fusible portion 32 by checking the gloss difference between the heat-sensitive deformation portion 10 and the non-textured region CSa2.

As illustrated in FIG. 8, the tab 3 including the fusible portion 32 may include a protruding portion 30 protruding toward the exterior case CS in a sectional view. The fusible portion 32 may be located at a top of the protruding portion 30. In other words, the tab 3 may include the protruding portion 30 having a protruding shape such that the fusible portion 32 protrudes toward the exterior case CS. Thus, when the overcurrent flows, the tab 3 can be blown at the top of the protruding portion 30. For example, the protruding portion 30 may be formed by bending or curving the first tab 34 and the second tab 36 located on both sides of the fusible portion 32 toward the exterior case CS on the fusible portion 32 side. Due to such a protruding portion 30, the fusible portion 32 may be positioned to be closer to the exterior case CS than the first tab 34 and the second tab 36. Thus, the heat generated in the fusible portion 32 can be more suitably transferred to the heat-sensitive deformation portion 10.

Such a protruding portion 30 may be elastically deformable in the thickness direction T of the exterior case CS. Such a protruding portion 30 may be sandwiched between the exterior case CS and the battery CB in an elastically compressed state inside the exterior case CS. The elastically compressed protruding portion 30 can exert a biasing force between the exterior case CS and the battery CB. Specifically, by housing the protruding portion 30 in the exterior case CS in the elastically compressed state, the fusible portion 32 located at the top of the protruding portion 30 can be biased toward the exterior case CS. With such a structure, the fusible portion 32 can be pressed against the exterior case CS side. Thus, the heat generated in the fusible portion 32 can be more suitably transferred to the heat-sensitive deformation portion 10 located in the exterior case CS.

For example, as illustrated in FIG. 8, the protruding portion 30 may be elastically deformable by having a stepped shape that is bent stepwise toward the exterior case CS. That is, in the protruding portion 30, the protruding portion 30 having the stepped shape may be formed by bending each of the first tab 34 and the second tab 36 in a crank shape on both sides of the fusible portion 32. With such a bent shape, the protruding portion 30 is elastically deformable in the thickness direction T of the exterior case CS inside the exterior case CS.

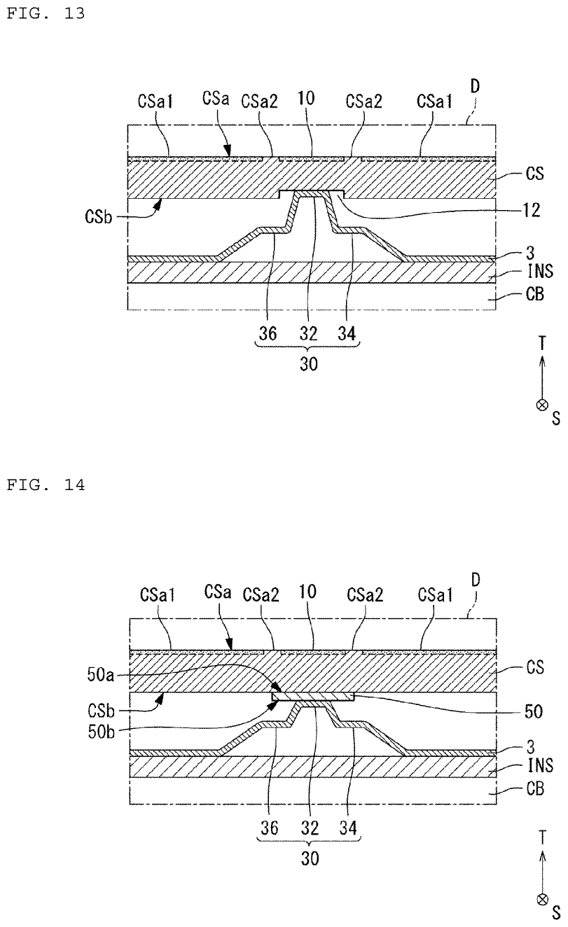

Next, a modification of the battery pack BP will be described with reference to FIGS. 13 to 19. Note that in describing the battery pack BP of the modification, description of a point common to the above description will be appropriately omitted. That is, points different from the above description will be mainly described below.

FIG. 13 is an enlarged sectional view schematically illustrating the periphery of the heat-sensitive deformation portion 10 of the battery pack BP according to a first modification. As illustrated, the exterior case CS may include a recessed region 12 in which the inner surface CSb of the exterior case CS is relatively recessed in a region including the heat-sensitive deformation portion 10. That is, the exterior case CS may have a relatively reduced thickness by including the heat-sensitive deformation portion 10 on the outer surface CSa while including the recessed region 12 on the inner surface CSb opposite the heat-sensitive deformation portion 10. The thickness of the exterior case CS may be locally reduced by the inner surface CSb being recessed in the region including the heat-sensitive deformation portion 10.

In the battery pack BP of the present disclosure, from the viewpoint of improving the thermal responsiveness of the heat-sensitive deformation portion 10 due to the heat transferred from the fusible portion 32, the thermal conductivity from the fusible portion 32 to the heat-sensitive deformation portion 10 is preferably higher. With the above-described structure including the recessed region 12, by reducing the thickness of the exterior case CS, the distance between the heat-sensitive deformation portion 10 located on the outer surface CSa of the exterior case CS and the fusible portion 32 located inside the exterior case CS can be shortened. Thus, the heat generated in the fusible portion 32 can be suitably transferred to the heat-sensitive deformation portion 10. The blown state of the fusible portion 32 from the fusible portion 32 can be more clearly reflected by the heat-sensitive deformation portion 10.

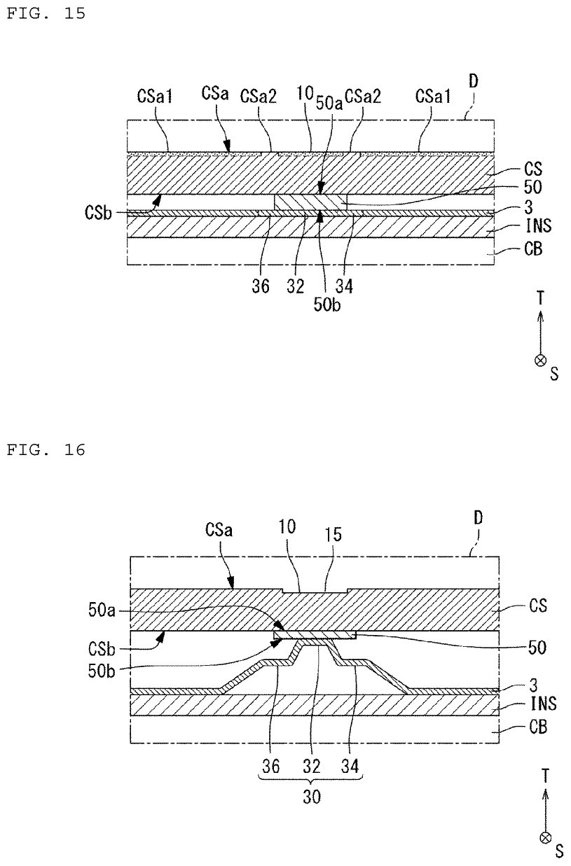

FIGS. 14 and 15 are enlarged sectional views schematically illustrating the periphery of the heat-sensitive deformation portion 10 of the battery pack BP according to a second modification. As illustrated, the battery pack BP may further include a heat transfer portion 50 positioned between the heat-sensitive deformation portion 10 and the fusible portion 32. The heat transfer portion 50 can transfer heat to both the heat-sensitive deformation portion 10 and the fusible portion 32. The heat-sensitive deformation portion 10 and the fusible portion 32 may be connected in a thermally conductive manner with the heat transfer portion 50 interposed therebetween.

The heat transfer portion 50 may be located inside the exterior case CS. Therefore, the heat transfer portion 50 may be sandwiched between the exterior case CS and the battery module BM so as to be positioned between the heat-sensitive deformation portion 10 and the fusible portion 32. Such a heat transfer portion 50 can be understood as an intermediate member having thermal conductivity, and can also be referred to as a heat transfer intermediate member or the like. Such a heat transfer portion 50 may function as a heat collecting member from the viewpoint of efficiently transferring the heat generated in the fusible portion 32 to the heat-sensitive deformation portion 10.

By providing the heat transfer portion 50, the heat generated in the fusible portion 32 is indirectly transferred to the heat-sensitive deformation portion 10 with the heat transfer portion 50 interposed therebetween. By disposing the heat transfer portion 50 between the fusible portion 32 and the heat-sensitive deformation portion 10 in this manner, a heat transfer path from the fusible portion 32 to the heat-sensitive deformation portion 10 can be formed. Thus, the heat generated in the fusible portion 32 can be more suitably transferred to the heat-sensitive deformation portion 10, and the thermal responsiveness of the heat-sensitive deformation portion 10 can be improved.

The heat transfer portion 50 includes a first main surface 50a and a second main surface 50b opposed to each other. As illustrated in FIG. 14, the first main surface 50a of the heat transfer portion 50 may be in contact with a region facing the heat-sensitive deformation portion 10 in the inner surface CSb of the exterior case CS. In other words, the heat transfer portion 50 is disposed to face the heat-sensitive deformation portion 10 in the thickness direction T of the exterior case CS, and may be in contact with the inner surface CSb of the exterior case CS on the first main surface 50a. On the other hand, the second main surface 50b of the heat transfer portion 50 may be in contact with the fusible portion 32. With such a structure, the heat transfer portion 50 may be in contact with both the exterior case CS and the fusible portion 32. Thus, the heat generated in the fusible portion 32 can be suitably transferred to the heat-sensitive deformation portion 10 located on the outer surface CSa side of the exterior case CS.

Furthermore, by using the heat transfer portion 50, the heat generated in the fusible portion 32 can be locally transferred to the heat-sensitive deformation portion 10 of the exterior case CS. For example, as illustrated in FIG. 15, also when the tab 3 extends substantially parallel to the inner surface of the exterior case CS over the first tab 34, the fusible portion 32, and the second tab 36, the heat transfer portion 50 is interposed between the exterior case CS and the fusible portion 32, so that it is possible to suppress transfer of the heat generated in the fusible portion 32 to a region (for example, the region CSa1) other than the heat-sensitive deformation portion 10 of the exterior case CS. Therefore, unintended deformation of the exterior case in the region other than the heat-sensitive deformation portion 10 can be suppressed.

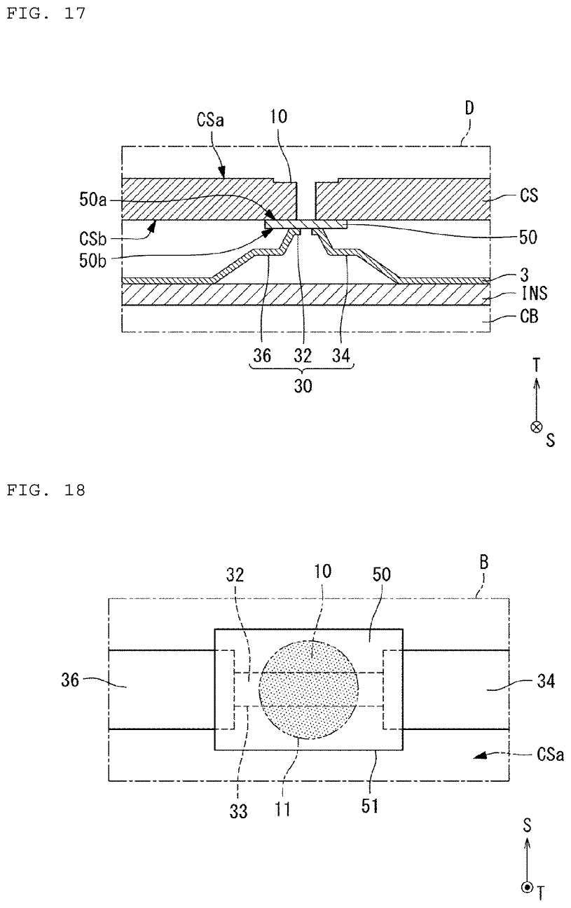

FIG. 16 is an enlarged sectional view schematically illustrating the periphery of the heat-sensitive deformation portion 10 of the battery pack BP according to a third modification. FIG. 17 is an enlarged sectional view schematically illustrating a state after the fusible portion 32 is blown in the battery pack BP illustrated in FIG. 16. As illustrated, the heat-sensitive deformation portion 10 may be configured to be cleaved by the heat transferred from the fusible portion 32 when the fusible portion 32 reaches the blowing temperature.

For example, as illustrated in FIG. 16, the battery pack BP may include the recess 15 formed by recessing the entire heat-sensitive deformation portion 10. The thickness of the exterior case CS may be locally reduced in the heat-sensitive deformation portion 10 by the recess 15. The heat-sensitive deformation portion 10 may be cleaved at the recess 15 by the heat transferred from the fusible portion 32 (see FIG. 17). Therefore, the recess 15 (see FIG. 16) of the heat-sensitive deformation portion 10 may be designed so that the heat-sensitive deformation portion 10 can be cleaved when the fusible portion 32 reaches the blowing temperature. With such a structure, the worker can determine whether the fusible portion 32 is blown by checking the presence or absence of cleavage of the heat-sensitive deformation portion 10.

In addition, when including the cleavable heat-sensitive deformation portion 10, another member such as the heat transfer portion 50 may be disposed inside the exterior case CS facing the heat-sensitive deformation portion 10. A hole opened in the exterior case CS by the cleavage of the heat-sensitive deformation portion 10 may be closed by the member. Thus, also after the heat-sensitive deformation portion 10 is cleaved, entry of moisture and/or foreign matter into the exterior case CS can be suppressed, and the battery module BM housed in the exterior case CS can be protected.

In addition, the worker may be able to determine that the heat-sensitive deformation portion 10 is cleaved by checking exposure of members such as the heat transfer portion 50 located inside the exterior case CS from the hole formed by the cleavage of the heat-sensitive deformation portion 10. From the viewpoint of making it easier for the worker to visually recognize the presence or absence of the cleavage (that is, the presence or absence of the exposure of the heat transfer portion 50 or the like), the members such as the heat transfer portion 50 and the outer surface CSa of the exterior case CS may be colored in different hues.

As described above, the heat transfer portion 50 can function to close the cleaved portion when the heat-sensitive deformation portion 10 is cleaved by the heat transferred from the fusible portion 32 (see FIG. 17). In addition, since the heat transfer portion 50 is located between the exterior case CS and the fusible portion 32, the exterior case CS can be protected from an end of the blown fusible portion 32. For example, also when the deformation of the heat-sensitive deformation portion 10 in the blown state of the fusible portion 32 is not accompanied by the cleavage, there is a possibility that the exterior case CS is unintentionally cleaved by a tip of the blown fusible portion 32 coming into contact with the exterior case CS. With the structure including the heat transfer portion 50 as illustrated in FIG. 16, it is possible to provide a structure in which the exterior case CS and the fusible portion 32 are not brought into contact with each other, and thus it is possible to suppress damage to the exterior case CS due to the blown fusible portion 32.

The heat transfer portion 50 may be formed of a material having thermal conductivity. Preferably, a material having appropriate thermal capacity and thermal resistance may be selected as the heat transfer portion 50 so that heat transfer portion 50 can transfer heat so that the heat-sensitive deformation portion 10 can be deformed when the fusible portion 32 reaches the blowing temperature, while the heat-sensitive deformation portion 10 is not deformed when the temperature of the fusible portion 32 is equal to or lower than the blowing temperature. For example, the heat transfer portion 50 may be formed of various materials such as metal, ceramics, a composite material of metal and ceramics, an inorganic material, or a resin having thermal conductivity. Although it is merely an example, the thermal resistance of the heat transfer portion 50 may be, for example, 1900°C./W or less. In addition, when importance is placed on suitably protecting the exterior case CS from the blown fusible portion 32, it is more preferable that the heat transfer portion 50 is formed of a material having more excellent heat resistance than the exterior case CS.

FIG. 18 is a partly enlarged view of the heat-sensitive deformation portion 10 viewed from the outside of the exterior case CS. In the figure, positions of the heat transfer portion 50 and the tab 3 located inside the exterior case CS are indicated by broken lines. A plan view shape of the heat transfer portion 50 is not particularly limited, and may be any shape of a substantially circular shape, a substantially elliptical shape, a substantially polygonal shape such as a substantially rectangular shape, or an indefinite shape. As illustrated in FIG. 18, the heat transfer portion 50 may have an outside dimension larger than that of the fusible portion 32 as viewed in the thickness direction T of the exterior case CS. For example, when each of the heat transfer portion 50 and the fusible portion 32 has a rectangular shape, a length dimension and a width dimension of the heat transfer portion 50 may be larger than those of the fusible portion 32.

Specifically, as viewed in the thickness direction T of the exterior case CS, an outer edge 33 of the fusible portion 32 may be located on an inner peripheral side of an outer edge 51 of the heat transfer portion 50. In other words, the heat transfer portion 50 may extend to an outer peripheral side of the fusible portion 32 as viewed in the thickness direction T of the exterior case CS. As viewed in the thickness direction T of the exterior case CS, the fusible portion 32 may be disposed to overlap the heat transfer portion 50 over an entire region of the fusible portion 32. Thus, the heat generated in the fusible portion 32 can be suitably transferred to the heat-sensitive deformation portion 10 through the heat transfer portion 50. Furthermore, also after the fusible portion 32 is blown, since the heat transfer portion 50 is interposed between the fusible portion 32 and the exterior case CS over the entire fusible portion 32, the exterior case CS can be suitably protected.

In addition, an outer edge 11 of the heat-sensitive deformation portion 10 may be located on the inner peripheral side of the outer edge 51 of the heat transfer portion 50 as viewed in the thickness direction T of the exterior case CS. In other words, the heat transfer portion 50 may extend to the outer peripheral side of the heat-sensitive deformation portion 10 as viewed in the thickness direction T of the exterior case CS. When viewed in the thickness direction T of the exterior case CS, the heat-sensitive deformation portion 10 may be disposed to overlap the heat transfer portion 50 over an entire region of the heat-sensitive deformation portion 10. Thus, also when the exterior case CS is cleaved due to the deformation of the heat-sensitive deformation portion 10, the heat transfer portion 50 can suitably close the hole formed by the cleavage.

FIG. 19 is an enlarged sectional view schematically illustrating the periphery of the heat-sensitive deformation portion 10 of the battery pack BP according to a fourth modification. As illustrated, the exterior case CS may include the recessed region 12 in the inner surface CSb, and the heat transfer portion 50 may be disposed inside the recessed region 12. With such a structure, the thickness of the exterior case CS is reduced by the recessed region 12. Therefore, it is possible to efficiently transfer the heat from the fusible portion 32 to the heat-sensitive deformation portion 10 while protecting the exterior case CS by the heat transfer portion 50.

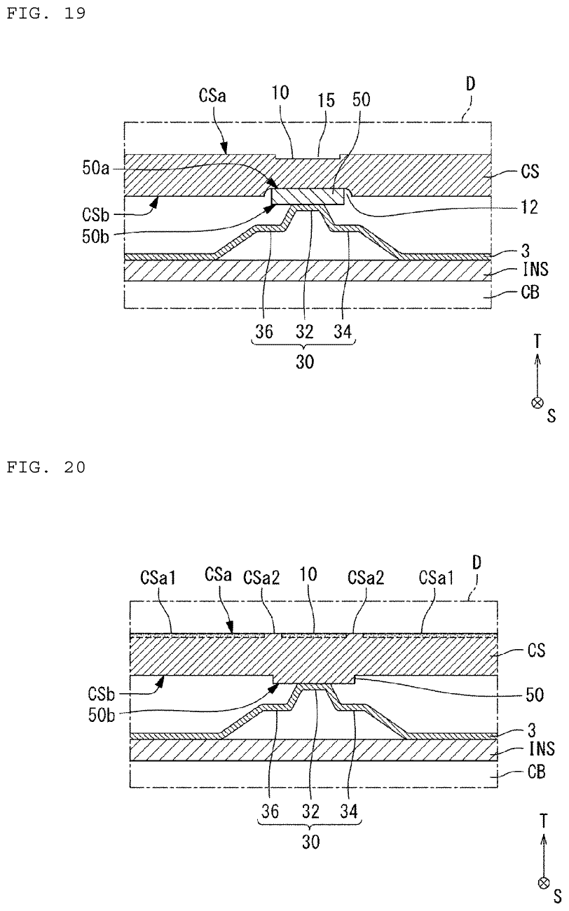

FIG. 20 is an enlarged sectional view schematically illustrating the periphery of the heat-sensitive deformation portion 10 of the battery pack BP according to a fifth modification. As illustrated, the heat transfer portion 50 may be positioned on the inner surface CSb of the exterior case CS and integrated with the exterior case CS. For example, the heat transfer portion 50 and the exterior case CS may be integrally molded. Therefore, the exterior case CS may include a protrusion protruding from the inner surface CSb toward the battery module BM, and the protrusion may function as the heat transfer portion 50. The fusible portion 32 may be in contact with a top surface 50b of the protruding heat transfer portion 50 protruding from the inner surface CSb of the exterior case CS.

Since the heat transfer portion 50 is integrally molded, the thickness of the exterior case CS locally increases in the region including the heat-sensitive deformation portion 10. Thus, strength of the exterior case CS in the heat-sensitive deformation portion 10 is increased, and it is possible to suppress unintended breakage of the exterior case due to an excessive deformation due to the heat transferred from the fusible portion 32.

Although the embodiments of the present disclosure have been described above, typical examples have been only illustrated. The embodiments disclosed herein are illustrative in all respects, and do not provide a basis for a limited interpretation. Therefore, the technical scope of the present disclosure is not to be construed only by the above-described embodiments, but is defined based on the description of the claims. In addition, the technical scope of the present disclosure includes meanings equivalent to the claims and all modifications within the scope.

Note that the above-described effects and the like are merely one example. Therefore, the present disclosure is not limited to the above matters, and may have additional effects.

Note that an embodiment of the present disclosure as described above includes the following preferred aspects.
<1> A battery pack including: an exterior case; and a battery module housed in the exterior case,
   in which the exterior case includes a connector electrically connected to the battery module and a heat-sensitive deformation portion positioned on an outer surface of the exterior case,
   the battery module includes a battery and a tab electrically connected to the battery and the connector,
   the tab includes a fusible portion, and
   the heat-sensitive deformation portion and the fusible portion are connected to each other in a thermally conductive manner.
<2> The battery pack according to <1>, in which the heat-sensitive deformation portion is disposed to face the fusible portion in a thickness direction of the exterior case.
<3> The battery pack according to <1> or <2>, in which the heat-sensitive deformation portion includes a recess in which a thickness of the exterior case is partly reduced.
<4> The battery pack according to any one of <1> to <3>, in which the heat-sensitive deformation portion includes a textured region.
<5> The battery pack according to <4>, in which the exterior case further includes a non-textured region adjacent to the textured region of the heat-sensitive deformation portion on the outer surface of the exterior case.
<6> The battery pack according to any one of <1> to <5>, in which the exterior case includes a recessed region in which an inner surface of the exterior case is relatively recessed in a region including the heat-sensitive deformation portion.
<7> The battery pack according to any one of <1> to <6>,
   in which the tab includes a protruding portion protruding toward the exterior case in a sectional view, and
   the fusible portion is located at a top of the protruding portion.
<8> The battery pack according to <7>,
   in which the protruding portion is elastically deformable in a thickness direction of the exterior case, and
   the protruding portion is sandwiched between the battery and the exterior case in an elastically compressed state.
<9> The battery pack according to any one of <1> to <8>, in which the fusible portion is in contact with an inner surface of the exterior case at a position facing the heat-sensitive deformation portion.
<10> The battery pack according to any one of <1> to <9>, further including a heat transfer portion positioned between the heat-sensitive deformation portion and the fusible portion,
   in which the heat-sensitive deformation portion and the fusible portion are connected in a thermally conductive manner with the heat transfer portion interposed therebetween.
<11> The battery pack according to <10>,
   in which the heat transfer portion includes a first main surface and a second main surface facing each other,
   the first main surface is in contact with a region of an inner surface of the exterior case, the region facing the heat-sensitive deformation portion, and
   the second main surface is in contact with the fusible portion.
<12> The battery pack according to <10> or <11>, in which an outer edge of the heat transfer portion is positioned outside an outer edge of the fusible portion as viewed in a thickness direction of the exterior case.
<13> The battery pack according to any one of <1> to <12>, in which the exterior case includes a resin material.

The present disclosure can be suitably used as a battery pack capable of externally checking an interruption state of a current path.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
an exterior case; and
a battery module housed in the exterior case,
wherein the exterior case includes a connector electrically connected to the battery module and a heat-sensitive deformation portion positioned on an outer surface of the exterior case,
the battery module includes a battery and a tab electrically connected to the battery and the connector,
the tab includes a fusible portion, and
the heat-sensitive deformation portion and the fusible portion are connected to each other in a thermally conductive manner.

2. The battery pack according to claim 1, wherein the heat-sensitive deformation portion is disposed to face the fusible portion in a thickness direction of the exterior case.

3. The battery pack according to claim 1, wherein the heat-sensitive deformation portion includes a recess in which a thickness of the exterior case is partly reduced.

4. The battery pack according to claim 1, wherein the heat-sensitive deformation portion includes a textured region.

5. The battery pack according to claim 4, wherein the exterior case further includes a non-textured region adjacent to the textured region of the heat-sensitive deformation portion on the outer surface of the exterior case.

6. The battery pack according to claim 1, wherein the exterior case includes a recessed region in which an inner surface of the exterior case is relatively recessed in a region including the heat-sensitive deformation portion.

7. The battery pack according to claim 1,
wherein the tab includes a protruding portion protruding toward the exterior case in a sectional view, and
the fusible portion is located at a top of the protruding portion.

8. The battery pack according to claim 7,
wherein the protruding portion is elastically deformable in a thickness direction of the exterior case, and
the protruding portion is sandwiched between the battery and the exterior case in an elastically compressed state.

9. The battery pack according to claim 1, wherein the fusible portion is in contact with an inner surface of the exterior case at a position facing the heat-sensitive deformation portion.

10. The battery pack according to claim 1, further comprising a heat transfer portion positioned between the heat-sensitive deformation portion and the fusible portion,
wherein the heat-sensitive deformation portion and the fusible portion are connected in a thermally conductive manner with the heat transfer portion interposed therebetween.

11. The battery pack according to claim 10,
wherein the heat transfer portion includes a first main surface and a second main surface facing each other,
the first main surface is in contact with a region of an inner surface of the exterior case, the region facing the heat-sensitive deformation portion, and
the second main surface is in contact with the fusible portion.

12. The battery pack according to claim 10, wherein an outer edge of the heat transfer portion is positioned outside an outer edge of the fusible portion as viewed in a thickness direction of the exterior case.

13. The battery pack according to claim 1, wherein the exterior case includes a resin material.
